(19) United States
(12) Patent Application Publication
(10) Pub. No.: US 2018/0096440 A1
(43) Pub. Date: Apr. 5, 2018

(54) Restaurant Specific Personalization

(71) Applicant: Amazon Technologies, Inc., Seattle, WA (US)

(72) Inventors: Gustavo Eduardo Lopez, Seattle, WA (US); Neha Gureja, Seattle, WA (US); Pawan Lata Uppuluri, Issaquah, WA (US)

(21) Appl. No.: 14/755,308

(22) Filed: Jun. 30, 2015

(51) Int. Cl. G06Q 50/12; G06Q 10/02; G06Q 30/02

(52) U.S. Cl. CPC G06Q 50/12; G06Q 10/02; G06Q 30/0226; G06Q 30/0224; G06Q 30/0259; G06Q 30/0255

(57) ABSTRACT

Personalizing recommendations for users based at least in part on learning user patterns that are specific to individual entities is described. A service provider may determine data associated with interactions between users and an entity and may determine, based on the data, patterns associated with a user of the users and the entity. The patterns may represent affinities between the user and at least one of goods or services offered by the entity. The service provider may determine entity data associated with the entity and, based at least in part on an availability of at least one of the goods or the services, may generate recommendations associated with the patterns and the entity data.

### BACKGROUND

The restaurant industry has traditionally been an industry that is reliant on personal interactions. A large proportion of the restaurant industry is driven by factors that are dependent on humans and accordingly, are difficult to predict. For instance, unlike other industries such as the airline industry or theater industry where all seats are reserved for a same starting time, tables at a restaurant become available at various times depending on a variety of factors such as an amount of time that patrons occupy the tables, the food and/or beverages that the patrons order, a number of tables in a server's section, etc. Accordingly, the restaurant industry has been reluctant to adopt online technology. As such, the restaurant industry poses new challenges in the world of e-commerce and online technology.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram showing an example system for identifying patterns associated with a user and leveraging the patterns to personalize recommendations to users.

FIG. 2 is a flow diagram showing an illustrative process to generate recommendations for users based on learning patterns associated with a user.

FIG. 3 is a flow diagram showing an illustrative process to perform actions associated with recommendations that are based on patterns associated with a user.

FIG. 4 is a flow diagram showing an illustrative process to infer patterns associated with a first user based on patterns associated with a second user.

FIG. 5 is a flow diagram showing an illustrative process to share data between entities.

FIG. 6 is a flow diagram showing an illustrative process to provide patterns associated with a user and an entity to the entity.

FIG. 7 is a diagram showing an example user interface that may be presented to a user with a recommendation that is based on patterns associated with a user.

FIG. 8 is a diagram showing another example user interface that may be presented to a user with a recommendation that is based on patterns associated with a user.

FIG. 9 is a diagram showing yet another example user interface that may be presented to a user with a recommendation that is based on patterns associated with a user.

### DETAILED DESCRIPTION

Techniques to personalize recommendations for users based at least in part on learning patterns associated with a user that are specific to individual entities are described herein. The techniques described herein enable entities to connect with users in a narrowly tailored manner that is specific to individual users and/or users who are a part of a same social graph. Leveraging data associated with users (e.g., user data) and patterns associated with the individual users and individual entities enables entities to lessen impersonal, generalized communications and streamline user interactions by personalizing communications. By personalizing communications between users and entities, entities may find and retain loyal, repeat customers.

In at least one example, the techniques described herein include accessing data relating to users associated with individual devices (e.g., user devices). The data may represent interactions and/or behavior exhibited by a user in association with a plurality of entities that offer one or more goods and/or one or more services. The techniques described herein further include determining, from the data, patterns associated with users and individual entities of the plurality of entities, and comparing the patterns to data associated with an entity (e.g., entity data) to determine and/or generate recommendations that are personalized for individual users and the individual entities. The techniques described herein may cause the recommendations to be presented to the user via a user interface associated with the user device. The one or more recommendations may be personalized in frequency and/or content based on the patterns.

The techniques described herein may be applied to various applications. That is, the techniques described herein include identifying patterns between users and individual entities and leveraging the patterns to personalize recommendations for the users. For the purpose of this discussion, entities may include individuals or merchants, such as restaurants, spas, retail stores, fitness facilities, etc., as described below. The entities each may offer one or more goods and/or one or more services. The services may include food and/or beverage services, spa services, personal styling services, fitness services, etc. For the purpose of this discussion, restaurants may include establishments where food and/or beverages are prepared and provided to customers (e.g., steakery, café, food truck, etc.).

The techniques described herein may leverage data associated with users to determine patterns associated with individual users. For the purpose of this discussion, patterns corresponding to individual users 106 (e.g., user patterns) may be indicative of individual user behaviors and/or interactions with respect to individual entities and/or affinities between users and goods and/or services offered by the entities. In at least one example, a user pattern may indicate that a user interacted with an entity via a particular interaction (e.g., requested a good and/or service, requested and/or occupied a table, etc.) at a frequency above a predetermined threshold and/or a predetermined number of times (possibly during a predetermined time period), and as a result, is likely to interact with the entity in a same and/or related interaction (e.g., request a same and/or similar good and/or service, request and/or occupy a same and/or similar table, etc.) in the future. That is, the user patterns represent propensities of users to interact with an entity via a particular interaction (e.g., request a good and/or service, request and/or occupy a table, etc.) based at least in part on past interactions of the users.

The techniques described herein may compare the user patterns with data associated with an entity to personalize the frequency and/or content of recommendations to users associated with the user patterns. The recommendations may include deals, reservations, actions to be provided by the entity, invitations to events, etc.

As described above, the techniques described herein may learn user patterns and may personalize recommendations to the user based on the user patterns. In a non-limiting example, the service provider may learn that a user regularly orders a squash and sweet potato salad when he or she patronizes Restaurant A. One day, Restaurant A may decide to make the squash and sweet potato salad the special for the day. The service provider may determine and/or generate a recommendation for the user that conveys to the user that the squash and sweet potato salad is a special that day. In at least one example, the recommendation may include a deal that is redeemable at Restaurant A and/or mechanism for scheduling a reservation. Or, perhaps Restaurant A and/or the service provider described herein want to encourage the user to try another item on the menu. Accordingly, the service provider may recommend a new menu item at Restaurant A. The recommendation may include a deal for the new menu item and/or a mechanism for scheduling a reservation. The recommendation for the new menu item may be based on user patterns, as described below.

Additionally and/or alternatively, the service provider may determine that a user is a loyal user of the entity and/or the service provider and may provide unexpected and/or premium benefits to the user as a result. A loyal user may be a user who spends an amount of money above a predetermined threshold at an entity and/or via the service provider, patronizes an entity and/or the service provider at a frequency above a predetermined threshold, patronizes an entity and/or the service provider a predetermined number of times, etc. Loyal users may receive premium benefits, or benefits that are different from benefits associated with non-loyal users that seek to reward loyal users for their loyalty to the entity. In some examples, loyal users may receive recommendations for the premium benefits when they are not expecting to receive a benefit. Examples of premium benefits may include seating at a prime table, discounts on menu items, expedited service, etc. In a non-limiting example, the service provider may determine that a user is a loyal user at Restaurant B. At a time unknown to the user, for instance, if the service provider and/or restaurant detect the user's presence at Restaurant B, the service provider, on behalf of the service provider and/or Restaurant B, may recommend a premium benefit to the user.

In some examples, the service provider may leverage the user patterns to perform actions associated with the user patterns. In a non-limiting example, the service provider may learn that a user may order pho from Restaurant C every Tuesday at 11:30 am. As a result, the service provider may send a recommendation to the user every Tuesday at 11:00 am indicating that Restaurant C will begin preparing the user's order so that it is ready for pick-up at 11:30 am. In some examples, the recommendation may request the user to confirm or cancel the recommendation. In additional or alternative examples, the service provider may not send a recommendation to the user and may simply send instructions to Restaurant C to begin preparing the user's order at 11:20 am on Tuesday without user commitment. Accordingly, when the user arrives to place and/or pick-up his or her order, the order is already prepared for the user.

In additional and/or alternative examples, the service provider may provide information to entities enabling entities to leverage user patterns to improve their goods and/or services, interactions with users, targeted marketing, etc. In a non-limiting example, the service provider may provide information to entities that indicates which menu items are most popular (e.g., ordered at a frequency above a predetermined threshold and/or a predetermined number of times) to enable the entities to evolve the goods and/or services they offer. In another non-limiting example, the service provider may provide information to entities indicating that a particular user has a reservation and that the user pattern associated with the user indicates that the user has an affinity for a particular good and/or service, such as, a particular bottle of wine. The entity (e.g., a restaurant) may leverage the information to confirm that the particular bottle of wine is in stock and/or reserve the particular bottle of wine for the user so that when the user arrives for his or her reservation, the entity is prepared with the particular bottle of wine. Additionally or alternatively, the service provider may share information about users who patronize a first entity with a second entity to enable the second entity to market to users who have particular user patterns that are likely to make the second entity more successful.

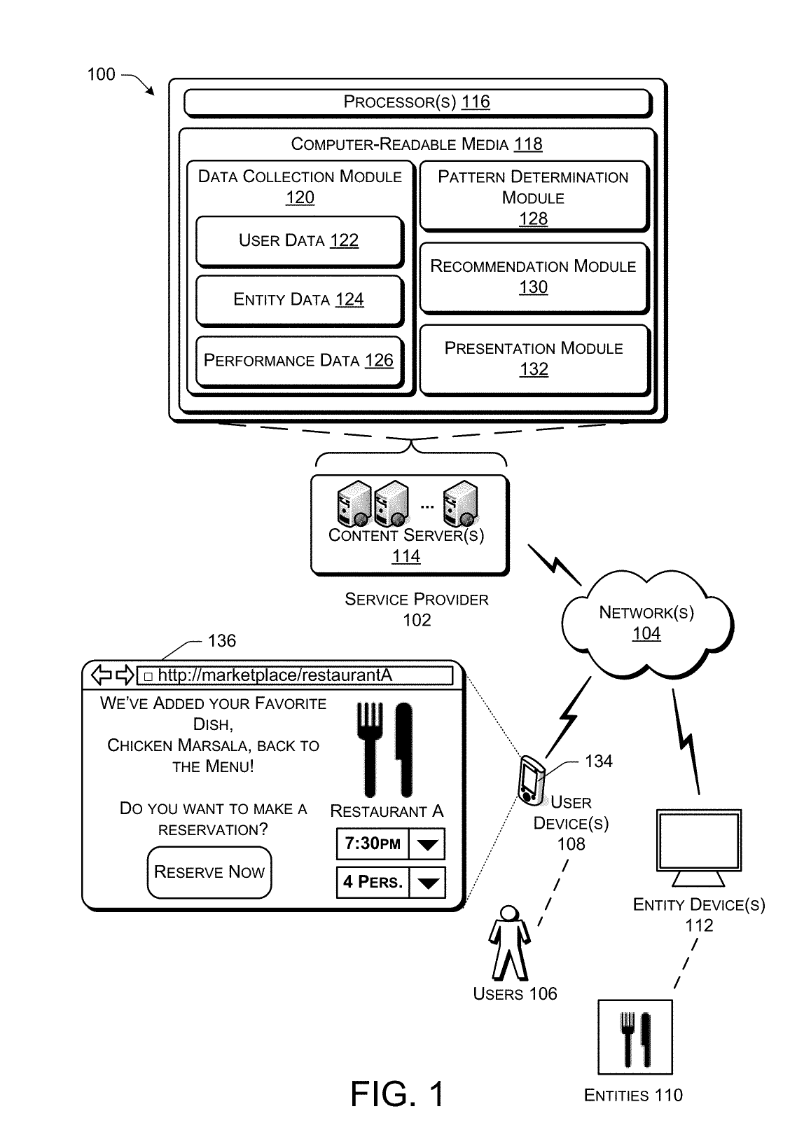

FIG. 1 is a diagram showing an example system 100 for identifying user patterns and leveraging the user patterns to personalize recommendations to users. More particularly, the system 100 may include a service provider 102, one or more network(s) 104, one or more users 106, one or more user devices 108 associated with the one or more users 106, one or more entities 110, and one or more entity devices 112 associated with the one or more entities 110.

The service provider 102 may be any entity, server(s), platform, etc., that enables the user devices 108 to communicate with the entity devices 112. In various examples, the service provider 102 may access user data to learn patterns from the user data and/or access entity data for making recommendations based on user patterns and entity data. The recommendations may include recommendations for reservations, deals, invitations to events, actions to be provided by the entity, etc. The service provider 102 may be implemented in a non-distributed computing environment or may be implemented in a distributed computing environment, possibly by running some modules/applications on user devices 108, entity devices 112, or other remotely located devices. As shown, the service provider 102 may include one or more content server(s) 114, which may include one or more processor(s) 116 and computer-readable media 118. The content server(s) 114 may also include additional components not listed above that may perform any function associated with the content server(s) 114. In various embodiments, each of the content server(s) 114 may be any type of server, such as a network-accessible server.

In some examples, the network(s) 104 may be any type of network known in the art, such as the Internet. Moreover, the service provider 102, user devices 108, and/or entity devices 112 may communicatively couple to the network(s) 104 in any manner, such as by a wired or wireless connection. The network(s) 104 may facilitate communication between the content server(s) 114, the user devices 108 associated with the users 106, and/or the entity devices 112 associated with the entities 110.

In at least one example, the user 106 may interact with the service provider 102 via a corresponding device (e.g., user device 108). The user device 108 may include a display for presenting a site (i.e., a website), a self-service portal, a self-service interface, etc. to the users 106, one or more mechanisms configured to receive user input (e.g., voice input, biometric input, etc.), etc. The user device 108 may include software, applications, etc., that are associated with the service provider 102. As a result, the service provider 102 may obtain or access information from (e.g., user data, etc.), and/or provide information to, the user 106. In at least one example, the users 106 may include consumers interacting with the service provider 102 to request and/or receive goods and/or services at, or associated with, an entity 110. For instance, a user 106 may make a reservation and/or place an order for food and/or drinks at a restaurant, the user 106 may schedule a manicure at a nail salon, reserve exercise machine/equipment at a fitness facility, etc. In at least one example, an agent (e.g., virtual assistant, co-worker, friend, etc.) may request the goods and/or services on behalf of the user 106.

In various examples, the users 106 may request goods and/or services by actuating a control on a user interface presented on a display 132 of a user device 108. The control may be associated with an application associated with the service provider 102 or a hyperlink that directs the user 106 to a new user interface and prompts the user 106 to input additional information for making the request for the goods and/or services. In other examples, the users 106 may request goods and/or services by interacting with the user device 108 via one or more inputs (e.g., user inputs), including but not limited to voice inputs, biometric inputs, etc. Based at least in part on requesting goods and/or services over the computer network, the user 106 may arrive at the physical location (e.g., restaurant, salon or spa, etc.) and have access to or receive the goods and/or services offered by a corresponding entity 110. In some examples, a user 106 may pay for goods and/or services using his or her user device 108. That is, based at least in part on requesting goods and/or services at the physical location, the user 106 may pay for his or her requested goods and/or services at the physical location (e.g., restaurant, salon or spa, etc.) via a computer network (e.g., service provider 102) using his or her user device 108.

In various examples, the entities 110 may be any individual or merchant that provides goods and/or services at a physical location. Additionally, the entities 110 may offer their goods and/or services at a merchant-branded merchant site (e.g., website), an intermediary marketplace, etc. In at least one example, the entities 110 may interact with the service provider 102 via an entity device 112. The entity device 112 may include a display for presenting a site (i.e., a website), a self-service portal, a self-service interface, etc. to the entities 110, one or more mechanisms configured to receive input (e.g., voice input, biometric input, etc.), etc. In various examples, the entity devices 112 may be a device associated with the service provider 102 that is in the possession of an entity 110. That is, the entity devices 112 may be provided to the entity 110 by the service provider 102. In other embodiments, the entity devices 112 may include software, applications, etc., that are associated with the service provider 102. As a result, the service provider 102 may obtain or access information from, and/or provide information to, the entity 110.

In some examples, the entity devices 112 may be point of sale (POS) devices, communicatively coupled to the service provider 102. POS systems may include computerized networks that are operated by main computers and are linked to several checkout terminals. A POS device may be one of the main computers or checkout terminals in the POS system. POS systems are often used by merchants (e.g., entities 110) for completing transactions. In the restaurant industry, POS systems may include software for creating and printing guest checks, printing orders to kitchens and bars for preparation, processing credit cards and other forms of payment, running reports, etc. In addition, some POS systems include software to enable restaurant employees to manage waiting lists and reservations. In other service industries (e.g., salons, spas, mechanics, etc.), POS systems may include software for creating and printing guest checks, processing credit cards and other forms of payment, running reports, etc. In addition, some POS systems include software to enable service employees to manage walk-ins and appointments.

In some examples, the users 106 may operate corresponding user devices 108 to perform various functions associated with the user devices 108, which may include at least some of the operations and/or modules discussed above with respect to the service provider 102. Additionally, in some examples, the entities 110 may operate corresponding entity devices 112 to perform various functions associated with the entity devices 112, which may include at least some of the operations and/or modules discussed above with respect to the service provider 102.

As shown, the service provider 102 may include one or more content server(s) 114, which may include one or more processor(s) 116 and computer-readable media 118. In various examples, the processor(s) 116 may execute one or more modules and/or processes to cause the content server(s) 114 to perform a variety of functions, as set forth above and explained in further detail in the following disclosure. In some embodiments, the processor(s) 116 may include a central processing unit (CPU), a graphics processing unit (GPU), both CPU and GPU, or other processing units or components known in the art. Additionally, each of the processor(s) 116 may possess its own local memory, which also may store program modules, program data, and/or one or more operating systems.

In at least one configuration, the computer-readable media 118 of the content server(s) 114 may include any components that may be used to facilitate interaction between the service provider 102, the users 106, and/or the entities 110. The components may represent pieces of code executing on a computing device. The computer-readable media 118 may include a data collection module 120, storing user data 122, entity data 124, and performance data 126, a pattern determination module 128, a recommendation module 130, a presentation module 132, etc. Depending on the exact configuration and type of the content server(s) 114, the computer-readable media 118 may also include volatile memory (such as RAM), non-volatile memory (such as ROM, flash memory, miniature hard drive, memory card, or the like), or some combination thereof.

The data collection module 120 may receive, access, and/or infer data associated with users 106 (e.g., user data 122) from the users 106 and/or the entities 110, and/or receive, access, and/or infer data associated with users 106 via third party sources and systems (e.g., social networks, professional networks, partner webstore purchases, etc.). The user data 122 may include a database of users 106 and data corresponding to each of the individual users 106. The data collection module 120 stores at least some of the user data 122 and the pattern determination module 128 may leverage the user data 122 for learning (e.g., via machine learning) user patterns. As described above, a user pattern may indicate that a user 106 interacted with an entity 110 via a particular interaction (e.g., requested a good and/or service, requested and/or occupied a table, etc.) at a frequency above a predetermined threshold and/or a predetermined number of times (possibly during a predetermined time period).

As described above, the data collection module 120 may receive and/or access user data 122 from users 106 and/or entities 110. In some examples, users 106 may input user data 122 when they set up a user account or profile for interacting with the service provider 102. The user 106 may provide demographic information (gender, age, profession, food allergies, etc.), calendar information (birthdays, holidays, anniversaries, etc.), etc. to the data collection module 120. The demographic information, calendar information, etc. may be associated with the users 106 and/or friends of the users 106, family of the users 106, etc. Users 106 may provide preferences associated with a frequency in which the users 106 would like to receive recommendations.

Users 106 may also provide preferences for their goods and/or services. In one example, a user 106 may provide dining preferences. Dining preferences may include preferences associated with whether the users 106 prefer dine-in, take-out, or delivery. Dining preferences may include preferences associated with features users 106 prefer for the tables they occupy, servers users 106 prefer to serve them, other users 106 they prefer to dine with, food and/or beverages users 106 prefer to order, etc. As described above, users 106 may also provide preferences associated with food and/or beverages that the users 106 prefer to order. For instance, users 106 may indicate tastes (e.g., spicy, savory, sweet, etc.) that users 106 prefer, preparations (e.g., grilled, cooked, or steamed, shaken, stirred, or neat, etc.) that users 106 prefer, ingredients (e.g., poultry, beef, or fish, beer, wine, or distilled spirits, etc.) that users 106 prefer, etc.

Users 106 may also provide preferences for other types of entities 110 (e.g., spas, fitness facilities, etc.). For instance, users 106 may provide preferences for pedicure chairs users 106 prefer to occupy, technicians users 106 prefer to provide spa services, spa services users 106 prefer to order, etc. Additionally or alternatively, users 106 may provide preferences for classes (e.g., yoga, spinning, TRX, etc.) users 106 prefer, fitness stations (e.g., yoga mats, spinning bikes, TRX bands, etc.) that users 106 prefer, instructors that users 106 prefer, etc.

In some examples, the data collection module 120 may receive, access, and/or infer user data 122 based on the service provider 102 receiving user information and actions associated with a user account (e.g., purchases (e.g., orders), reservation requests, sales, browsing histories, search histories, recommendations, location proximity, etc.). In at least one example, the data collection module 120 may receive information based on a user 106 redeeming a previously acquired deal associated with an entity 110 via the service provider 102. In some examples, the data collection module 120 may receive information based on a user 106 making an order and/or payment to an entity 110 via an application associated with the service provider 102 and/or entity 110 that is stored on a user device 108. In other examples, the data collection module 120 may receive information based on entities 110 inputting information about the user 106 into entity devices 112 such as POS devices. In each of the above examples, the data collection module 120 may receive information about entities 110 that the user 106 patronized, a time, day, and/or date the user 106 patronized the entities 110, goods and/or services requested, received, and/or ordered by the user 106, how much the user 106 spent, how many other users 106 the user 106 patronized the entity 110 with, a rating of the entity 110, etc.

For the purpose of this discussion, deals may represent some form of value to be applied when items that are acquired by users in association with the deals, such as a discount, a coupon, a credit, a rebate, and the like. The deals may also represent an offer and/or promotion to acquire one or more items associated with the deals or may represent one or more advertisements associated with the deals. The deals may also be offered at any price point, including being offered at no cost, such as the users being offered a deal that includes an item at no additional cost to the user. The items offered in association with the deals may include tangible items, intangible items, products, goods, services, a bundle of items, digital goods, digital services, events, and the like.

The data collection module 120 may receive feedback data from a user 106 via a user device 108, entity device 112, etc. The data collection module 120 may receive feedback data based at least in part on the service provider 102 and/or entity 110 prompting a user 106 for feedback at a time after the user 106 had access to the services provided by the entities 110 and/or received goods provided by the entities 110. The feedback data may include user-provided feedback, user reviews, user ratings, user responses to surveys/questionnaires, etc. The data collection module 120 may receive, access, and/or infer preferences, interests, likes/dislikes, complaints, etc., of the users 106 based at least in part on the feedback data. In at least some examples, user interfaces associated with the recommendations may include mechanisms to enable a user 106 to indicate that a recommendation provided to the user 106 is not relevant to the user 106 and/or that the user 106 prefers not to receive same and/or similar recommendations in the future.

In other examples, the data collection module 120 may access user data 122 from third party sources and systems (e.g., social networks, professional networks, partner webstore purchases, etc.). In at least one example, the data collection module 120 may receive, access, and/or infer information from the third party sources and systems to determine users 106 who request and/or receive goods and/or services together, how many users 106 are in a party, how the different users 106 paid for the goods and/or services, what goods and/or services individual users 106 ordered and/or requested, etc. In at least one example, the data collection module 120 may access and/or determine social graphs associated with users 106 based on accessing user data 122 from third party sources and systems. In some examples, the data collection module 120 may utilize the social graphs to determine relationships between a user 106 and other users 106 that he or she requests and/or receives goods and/or services with. In additional or alternative examples, the data collection module 120 may access users' 106 social media updates, check-ins, photos, etc. As a result, the data collection module 120 may receive information about entities 110 that the users 106 patronized, a time and/or date the user 106 patronized the entity 110, goods and/or services ordered by users 106, other users 106 that users 106 requested and/or received the goods and/or services with, etc.

In some examples, the data collection module 120 may receive, access, and/or infer data that includes dates corresponding to holidays (e.g., religious, cultural, regional, national, etc.), events (e.g., concerts, plays, sporting events, festivals, etc.), etc. and/or dates that correspond to occasions that are personal to the users 106 (e.g., anniversaries, birthdays, other occasions, etc.). In at least one example, the data collection module 120 may receive, access, and/or infer data that includes dates corresponding to holidays, events, etc. from third party sources and systems. In additional or alternative examples, the data collection module 120 may receive, access, and/or infer user data 122 that includes dates that correspond to occasions that are personal to the users 106 by accessing profiles associated with the users 106 and/or third party sources and systems (e.g., social networks, professional networks, partner webstore purchases, etc.) associated with the users 106. In such examples, the pattern determination module 120 may learn user patterns from the user data 122 and leverage the user patterns to determine dates that correspond to occasions that are personal to the users 106, as described below.

The data collection module 120 may also receive, access, and/or infer data associated with the entities 110 (e.g., entity data 124). For restaurants, entity data 124 may include data associated with information about menu items (e.g., data associated with availability of menu items, ingredients in menu items, tastes of menu items, preparations of menu items, prices of menu items, etc.), specials (e.g., data associated with dishes offered at discounted prices, for a limited time, with a unique preparation, etc.), special events (e.g., data associated with dates corresponding to live music offerings, unique menu offerings, etc.), servers (e.g., data identifying which servers are serving at particular times, which tables the servers are serving, user ratings associated with the servers, etc.), tables (e.g., data associated with availability of tables, characteristics of tables, ratings of tables, wait times associated with tables, etc.), reservations (e.g., data indicating how many tables are reserved at dates and/or times, which tables are reserved, etc.), etc. For other entities 110, such as spas and/or fitness facilities, entity data 124 may include data associated with information about service menus, specials, special events, technicians, appointments, etc. and/or entity data 124 may include data associated with information about classes, specials, special events, instructors and/or trainers, appointments, etc., respectively.

The data collection module 120 may receive updated entity data 124 in predetermined time intervals (e.g., weekly, daily, hourly, etc.), responsive to an event associated with the entity 110, etc. For instance, for a restaurant, updated entity data 124 may include data indicating a new special (e.g., a menu item that previously was not on special is on special), menu changes (e.g., a menu item that was previously unavailable becomes available and/or a menu item that was previously available has become unavailable, new menu items, etc.), inventory changes (e.g., a menu item that was previously out of stock that is back in stock, or that was previously in stock but that is currently out of stock), etc. Updated entity data 124 may include data indicating that a table that previously was not available becomes available (e.g., reservation canceled, reservation no-showed, etc.), an event has been added to an event calendar associated with the entity 110, a server previously scheduled has been replaced with a different server, etc. The data collection module 120 may receive similar updated entity data 124 from other entities 110 such as spas, fitness facilities, etc.

The data collection module 120 may also receive, access, and/or infer performance data 126. In some examples, the data collection module 120 may leverage the performance data 126 to determine whether to send a recommendation to a user 106. The performance data 126 may include actions associated with user accounts indicating whether users 106 interact with recommendations sent by the service provider 102 and/or entity 110. For instance, the data collection module 120 may leverage the actions associated with the user accounts to determine performance data 126 such as a conversion rate, or a rate at which individual users 106 acquire and/or redeem deals recommended by the recommendation module 130, follow-through with requesting reservations recommended by the recommendation module 130, etc.

The pattern determination module 128 utilizes the user data 122 to learn patterns associated with the users 106. In at least one example, the user patterns may represent how a user 106 interacts with an entity 110 and/or affinities between users 106 and menu items, ingredients, tables, servers, events, etc. User patterns may be used to infer or predict how a user 106 is likely to interact with the entity 110 at a time in the future based on past user behaviors that occurred at a frequency above a predetermined threshold and/or a predetermined number of times (possibly during a predetermined time period), as described above. Learning how a user 106 has previously interacted with an entity 110 may allow the service provider 102 to predict how the user 106 will behave in the future, which may enable the service provider 102 and/or entity 110 to personalize the content and frequency of recommendations to the user 106, which may strengthen a user's 106 loyalty to the entity 110. The pattern determination module 128 may leverage machine learning algorithms, such as supervised machine learning algorithms, unsupervised machine learning algorithms, deep learning algorithms, etc., to learn the user patterns from the user data 122. In some examples, the pattern determination module 128 may determine (i.e., learn) user patterns with respect to individual entities 110.

In at least one example, the user patterns may correspond to a numerical value that represents a correlation between a user 106 and an interaction and/or behavior associated with an entity 110. In some examples, the numerical value may be associated with a binary value (e.g., 0 or 1), wherein 0 indicates that the user 106 does not have an affinity for an interaction and/or behavior and 1 indicates that the user 106 has an affinity for an interaction and/or behavior. In other examples, the numerical value may be associated with a range of numerical values, wherein a higher numerical value indicates a stronger correlation between the user 106 and the interaction and/or behavior associated with the entity 110 and a lower numerical value indicates a weaker correlation between the user 106 and the interaction and/or behavior associated with the entity 110. In at least some examples, the user patterns may correspond to the user 106 and one or more other users 106 who are associated with a same social graph as the user 106, as described below.

In at least one example, the pattern determination module 128 may determine user patterns that are associated with times, days, and/or dates. In some examples, the pattern determination module 128 may determine user patterns that correspond to holidays, events, occasions that are personal to the user 106 (e.g., birthdays, anniversaries, etc.), etc. In additional and/or alternative examples, the pattern determination module 128 may determine user patterns that correspond to frequencies. That is, the pattern determination module 128 may determine a rate at which users 106 exhibit user patterns (e.g., one time per day, one time per week, etc.).

With respect to restaurants, the pattern determination module 128 may determine user patterns associated with menu items (e.g., salads, appetizers, main dishes, beverages, desserts, etc.) users 106 order, characteristics associated with tables users 106 occupy (e.g., tables close to windows, tables that are outside, tall tables, etc.), servers users 106 request, events users 106 attend, etc. Additionally or alternatively, the pattern determination module 128 may determine user patterns associated with characteristics associated with menu items that a user 106 orders (e.g., taste, preparation, ingredients, etc.). The pattern determination module 128 may determine user patterns associated with whether a user 106 makes reservations, dines-in, orders delivery, and/or orders take-out.

As described above, the data collection module 120 may receive, access, and/or infer user data 122 based on the service provider 102 receiving user information and actions associated with a user account (e.g., purchases (e.g., orders), reservation requests, sales, browsing histories, search histories, recommendations, location proximity, etc.). In a non-limiting example, the data collection module 120 may determine that a user 106 orders a particular bottle of a wine at a frequency above a predetermined threshold and/or a predetermined number of times (possibly during a predetermined time period). Accordingly, the pattern determination module 128 may learn that the user 106 has an affinity (e.g., a numerical value above a predetermined threshold or a binary value of 1) for the particular bottle of wine and accordingly, the pattern determination module 128 may map the user pattern (the user's 106 affinity for the particular bottle of wine) to the user 106.

In another non-limiting example, a user 106 may order a chicken main dish at a frequency above a predetermined threshold and/or a predetermined number of times (possibly during a predetermined time period). For instance, on a first visit to Restaurant A, the user 106 may order a chicken masala main dish, on a second visit to Restaurant A, the user 106 may order a chicken teriyaki main dish, on a third visit to Restaurant A, the user 106 may order a barbeque chicken main dish, etc. The pattern determination module 128 may learn that the user 106 has an affinity (e.g., a numerical value above a predetermined threshold or a binary value of 1) for chicken main dishes and accordingly, the pattern determination module 128 may map the user pattern (the user's 106 affinity for the chicken main dishes) to the user 106.

In yet another non-limiting example, a user 106 may request, reserve, and/or occupy a same corner table at a frequency above a predetermined threshold and/or a predetermined number of times (possibly during a predetermined time period). Accordingly, the pattern determination module 128 may learn that the user 106 has an affinity (e.g., a numerical value above a predetermined threshold or a binary value of 1) for the corner table and accordingly, the pattern determination module 128 may map the user pattern (the user's 106 affinity for the corner table) to the user 106.

In some examples, a user 106 may request or be served by a same server at a frequency above a predetermined threshold and/or a predetermined number of times (possibly during a predetermined time period). Accordingly, the pattern determination module 128 may learn that the user 106 has an affinity (e.g., a numerical value above a predetermined threshold or a binary value of 1) for the server and accordingly, the pattern determination module 128 may map the user pattern (the user's 106 affinity for the server) to the user 106.

In additional and/or alternative examples, the pattern determination module 128 may determine negative user patterns (e.g., a numerical value below a predetermined threshold or a binary value of 0). For instance, based at least in part on determining affinities between a user 106 and an interaction with an entity 110, the pattern determination module 128 may infer a decreased affinity between the user 106 and other interactions with the entity 110. That is, the pattern determination module 128 may infer user patterns associated with interactions that users 106 do not prefer. In some examples, the negative user patterns and/or decreased affinities may be determined based on negative user feedback.

In a non-limiting example, a user 106 may request, reserve, and/or occupy a same corner table at a frequency above a predetermined threshold and/or a predetermined number of times (possibly during a predetermined time period) and the pattern determination module 128 may learn that the user 106 has an affinity for the corner table and does not have an affinity (e.g., a numerical value below a predetermined threshold or a binary value of 0) for tables in the center of a dining room. Accordingly, the pattern determination module 128 may determine a user pattern that the user 106 does not prefer tables in the center of the dining room. As another non-limiting example, a user 106 may order vegetarian menu items at a frequency above a predetermined threshold and/or a predetermined number of times (possibly during a predetermined time period). Accordingly, the pattern determination module 128 may learn that the user 106 has an affinity for vegetarian menu items and that the user does not have an affinity (e.g., a numerical value below a predetermined threshold or a binary value of 0) for meat menu items. Accordingly, the pattern determination module 128 may determine a user pattern that the user 106 does not prefer meat menu items. As yet another non-limiting example, a user 106 may dislike broccoli. The user 106 may reject menu items associated with broccoli at a frequency above a predetermined threshold and/or a predetermined number of times (possibly during a predetermined time period). The user 106 may reject the menu items by sending back the menu items, negatively reviewing the menu items, ordering menu items that do not have broccoli, etc. Accordingly, the pattern determination module 128 may learn that the user 106 does not have an affinity (e.g., a numerical value below a predetermined threshold or a binary value of 0) for menu items with broccoli. Accordingly, the pattern determination module 128 may determine a user pattern that the user 106 does not prefer menu items with broccoli.

The pattern determination module 128 may map each of the user patterns (e.g., the numerical values, etc.) to the respective users 106 in the user data 122. That is, the pattern determination module 128 may store the determined user patterns in a database associated with the user data 122 in the data collection module 120 and the user patterns may be associated with corresponding users 106 using identifiers, tags, labels, etc.

In at least one example, the pattern determination module 128 may determine user patterns for a user 106 based at least in part on comparing user data 122 associated with the user 106 to user data 122 associated with other users 106. The pattern determination module 128 may compare user data 122 associated with the first user 106 and the second user 106 and/or user patterns associated with the first user 106 and the second user 106 and may determine that the first user 106 and the second user 106 have at least some user data 122 and/or user patterns that are the same. Based at least in part on determining that at least a portion of the user data 122 and/or user patterns is/are associated with both the first user 106 and the second user 106, the pattern determination module 128 may infer user patterns for the first user 106 that are the same as the user patterns determined for the second user 106. The pattern determination module 128 may utilize machine learning algorithms, as described above, for inferring the user patterns for the first user 106 based at least in part on the user patterns associated with the second user 106.

The recommendation module 130 may leverage the user data 122 and user patterns to determine recommendations for the users 106. In at least one example, the recommendation module 130 may leverage the numerical values corresponding to the user patterns for determining recommendations for the users 106. In some examples, the recommendation module 130 may determine and send deals associated with individual entities 110 to the users 106 and/or invitations to events hosted and/or sponsored by individual entities 110 to the users 106. In other examples, the recommendation module 130 may determine recommendations that include mechanisms for scheduling reservations, ordering for dine-in, take-out, or delivery options, etc. to the users 106. In at least one example, the recommendation module 130 may determine recommendations associated with an action to be provided by an entity 110.

In some examples, the recommendation module 130 may determine recommendations for users 106 responsive to a triggering event, including but not limited to, receiving updated entity data, determining a time, day, and/or date associated with a user pattern and/or corresponding to holidays, events, dates that correspond to occasions that are personal to users 106, etc. is upcoming in a predetermined period of time (e.g., within one hour, within one day, within one week, etc.), detecting a presence of a user 106 at an entity 110, determining a numerical value corresponding to a user pattern exceeds a threshold value, receiving a reservation request from a user 106, etc. In other examples, the recommendation module 130 may determine recommendations for users 106 in predetermined time intervals (e.g., bi-annually, monthly, weekly, etc.), at a predetermined frequency (e.g., five times each month, one time each week, etc.), etc. In at least one example, the predetermined time intervals and/or predetermined frequencies are based at least in part on user input indicating user preferences with respect to how often the user 106 receives recommendations from the service provider 102 and/or entity 110 and/or user patterns associated with the predetermined time intervals and/or predetermined frequency.

In some examples, the recommendation module 130 may determine and send recommendations to the users 106 consistent with user patterns. For instance, if a user 106 interacts with entities 110 at a particular time and/or on a particular day, date, etc., the recommendation module 130 may recommend a reservation for the particular time, day, date, etc. If a user 106 exhibits an affinity for a menu item at an entity 110 (i.e., the pattern determination module 128 determined a user pattern between the user 106 and the menu item), the recommendation module 130 may recommend a deal for the menu item at the entity 110. If the user 106 exhibits an affinity for a particular live entertainer at the entity 110 (i.e., the pattern determination module 128 determined a user pattern between the user 106 and the events associated with the live entertainer), the recommendation module 130 may recommend a deal and/or reservation for a future date that the live entertainer is performing. If a user 106 interacts with an entity 110 in a particular manner (e.g., orders pho) at a particular time and/or on a particular day, date, etc., the recommendation module 130 may recommend an action to be provided by the entity 110 for streamlining the interaction between the user 106 and the entity 110 in the particular manner (e.g., ordering pho) for the particular time, day, date, etc.

In other examples, the recommendation module 130 may make recommendations to encourage changes in user patterns (e.g., recommendations that are inconsistent with user patterns). For instance, the recommendation module 130 may recommend a deal for a new menu item at an entity 110 to expose the user 106 to new menu items. Additionally or alternatively, the recommendation module 130 may recommend a reservation for a new table at an entity 110 to expose the user 106 to a new view and/or experience at the entity 110. The recommendation module 130 may leverage user data 122, user patterns, entity data 124, etc. in making the recommendations.

In at least one example, the recommendation module 130 may leverage user interactions between a user 106 and other users 106 who are a part of the user's 106 social graphs to personalize recommendations. In a non-limiting example, the pattern determination module 128 may determine that a user 106 interacts with User A, User B, and User C more than any other users 106. In some examples, one or more other users 106 who are in a same social graph as a user 106 (e.g., User A, User B, and/or User C) may have relationships with and/or exhibit similar behaviors (e.g., visit the same restaurants, same or similar dining preferences, etc.) to the user 106. In at least one example, the recommendation module 130 may leverage user data 122 and/or user patterns for a user 106 to determine and/or generate and send recommendations to other users 106 such as User A, User B, and/or User C.

In at least one example, the pattern determination module 128 may determine that the user 106 and User B have patronized Restaurant A at a frequency above a predetermined threshold and/or a predetermined number of times (possibly during a predetermined time period) and/or ordered a particular bottle of champagne at a frequency above a predetermined threshold and/or a predetermined number of times (possibly during a predetermined time period) when they patronized Restaurant A. The recommendation module 130 may access user data 122 indicating that User B's birthday is approaching (e.g., within one week, within one month, etc.). Accordingly, the recommendation module 130 may recommend a reservation at Restaurant A for User B and the user 106 on or before User B's birthday. In some examples, the recommendation module 130 may also include a deal to acquire the bottle of champagne at a discounted price and/or mechanism to reserve and/or pre-order the bottle of champagne at Restaurant A.

As another non-limiting example, the recommendation module 130 may determine that a user 106 is a loyal user, as described above, for a particular entity 110 and may determine and/or generate recommendations to provide the user 106 with an unexpected and/or premium benefit. The unexpected and/or premium benefit may be at a prime table (e.g., a popular table, a table with a great view, etc.), discounts on menu items, expedited service, etc. In at least one example, the recommendation module 130 may determine and/or generate the recommendations for unexpected and/or premium benefits based at least in part on detecting the user's 106 presence at the entity 110, as described below.

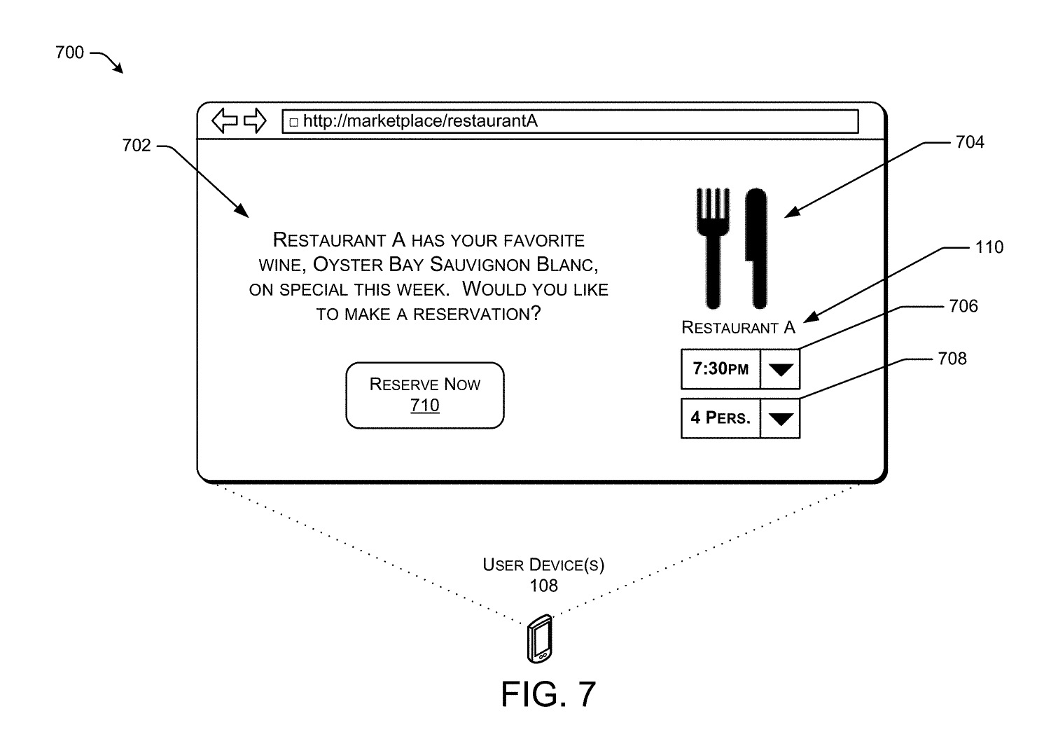

In at least one example, the recommendation module 130 may send recommendations to the presentation module 132. In some examples, the presentation module 132 may generate user interfaces that provide functionality to present personalized recommendations to users 106. The presentation module 132 may cause recommendations 136 to be presented to the users 106 on displays 134 of the user devices 108. In at least one example, the presentation module 132 may cause recommendations 136 to be presented to the user 106 via a user interface, email, text message, push notification, etc., as described below in FIGS. 7-9. The recommendations 136 may include recommendations for reservations, deals, actions to be provided by the entities 110, invitations to events, etc. For instance, the presentation module 132 may cause one or more recommendations to be presented to a user 106 in predetermined time intervals, at a predetermined frequency, responsive to a triggering event, on or before a date, etc., as described above.

In at least one example, the presentation module 132 may cause information to be presented to the entity devices 110. The presentation module 132 may generate user interfaces that provide functionality to present personalized information about users 106 to entities 110. In at least one example, the presentation module 132 may cause the information to be presented to the entity 110 via a user interface, email, text message, push notification, etc. In a non-limiting example, the presentation module 132 may provide a notification that the user 106 has an affinity for a particular menu item, table, server, etc. The entities 110 may access the information via the entity devices 112 and may perform an action that is consistent with the information. In a non-limiting example, the entity 110 may leverage the information to present a dessert that the user 106 exhibits an affinity for (e.g., via a determined user pattern) for a birthday celebration, to decant a bottle of wine that the user 106 exhibits an affinity for (e.g., via a determined user pattern) before users 106 arrive at the entity 110 for a reservation, place an order associated with a user pattern for a user 106, etc.

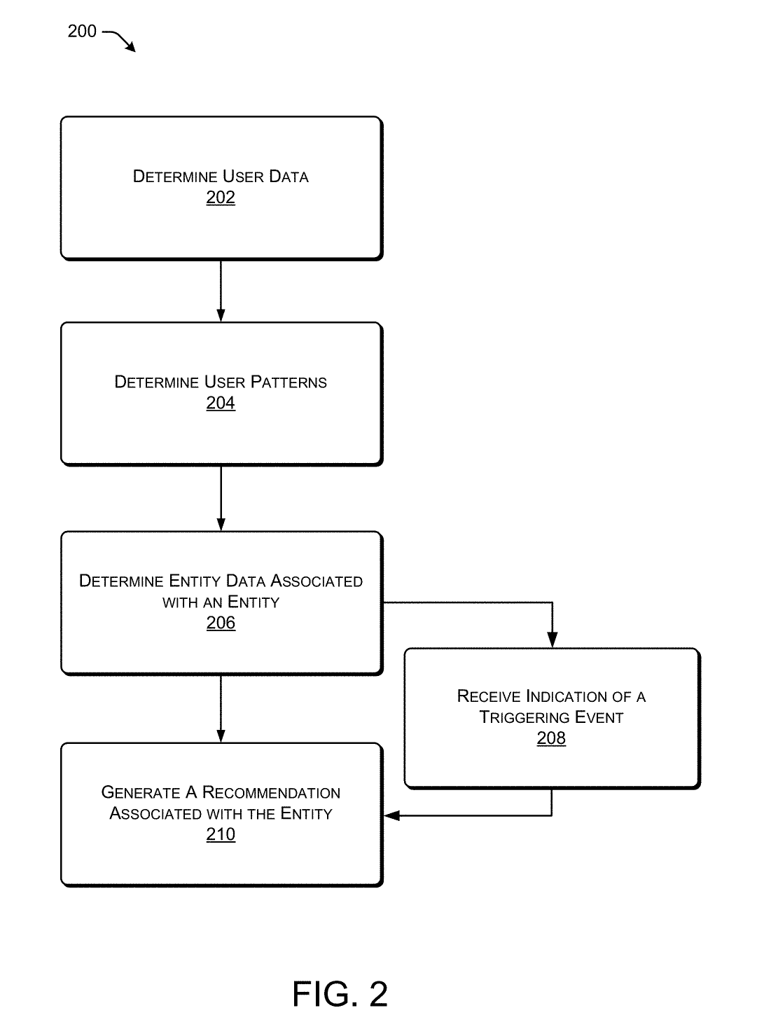

FIGS. 2-6 describe example processes for identifying user patterns and leveraging the user patterns to personalize recommendations associated with various entities 110 to users 106. For instance, processes 200-600 may be used to personalize recommendations associated with restaurants, spas, retail stores, fitness facilities, etc. The example processes are described in the context of the environment of FIG. 1 but are not limited to that environment. The processes are illustrated as logical flow graphs, each operation of which represents a sequence of operations that may be implemented in hardware, software, or a combination thereof. In the context of software, the operations represent computer-executable instructions stored on one or more computer-readable media 118 that, when executed by one or more processors 116, perform the recited operations. Generally, computer-executable instructions include routines, programs, objects, components, data structures, and the like that perform particular functions or implement particular abstract data types.

The computer-readable media 118 may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some embodiments the computer-readable media 118 may include a transitory computer-readable signal (in compressed or uncompressed form). Examples of computer-readable signals, whether modulated using a carrier or not, include, but are not limited to, signals that a computer system hosting or running a computer program may be configured to access, including signals downloaded through the Internet or other networks. The order in which the operations are described is not intended to be construed as a limitation, and any number of the described operations may be combined in any order and/or in parallel to implement the process. Furthermore, the operations described below may be implemented on a single device or multiple devices.

FIG. 2 is a flow diagram showing an illustrative process 200 to present recommendations to users 106 based on learning user patterns. The operations described with respect to FIG. 2 may be performed by the service provider 102 (e.g., the content servers 114) and/or an entity device 112, as described above and illustrated in FIG. 1.

Block 202 illustrates determining user data 122. The data collection module 120 may receive, access, and/or infer user data 122 from user devices 108, based on the service provider 102 receiving user information and actions associated with a user account, and/or from third party sources and systems, as described above. In at least one example, the data collection module 120 may receive, access, and/or infer user data 122 based at least in part on a user 106 redeeming previously acquired deals associated with the entities 110, the user placing orders and/or making reservations at the entities 110, or processing payment, via the user device 108, at the entities 110, etc., as described above. In additional or alternative examples, the data collection module 120 may receive user data 122 based at least in part on individuals associated with entities 110 manually entering information into an entity device 112, such as a POS device, that is integrated and/or otherwise associated with the service provider 102, as described above.

The user data 122 may include data representative of and/or associated with behavior exhibited by and/or interactions of a user 106 associated with individual entities 110, as described above. Generally, the user data 122 may include data associated with dining preferences at individual entities 110, including features users 106 prefer for the tables they occupy, servers users 106 prefer to serve them, other users 106 they prefer to dine with, menu items (e.g., food and/or beverages) users 106 prefer to order, etc. User data 122 may also include data associated with preferences associated with menu items that the users 106 like to order. For instance, user data 122 may include data associated with tastes (e.g., spicy, savory, sweet, etc.) that users 106 prefer, preparations (e.g., grilled, cooked, and/or steamed, shaken, stirred, and/or neat, etc.) that users 106 prefer, ingredients (e.g., poultry, beef, and/or fish, beer, wine, and/or distilled spirits, etc.) that users 106 prefer, etc. Additional or alternative user data 118 is described above.

Block 204 illustrates determining user patterns. The pattern determination module 128 may learn user patterns based on the user data 122 via one or more machine learning algorithms described above. As described above, the user patterns may represent user interactions with an entity 110 that have previously occurred at a frequency above a predetermined threshold and/or that have occurred a predetermined number of times (possibly during a predetermined time period), and as a result, are likely to represent a propensity of a user 106 to interact with entities 110 in a same manner in the future and/or affinities between a user 106 and menu items, ingredients, tables, servers, events, etc., associated with individual entities 110. As described above, with respect to restaurants, the pattern determination module 128 may determine user patterns associated with menu items (e.g., salads, appetizers, main dishes, beverages, desserts, etc.) users 106 order, characteristics associated with tables users 106 occupy (e.g., tables close to windows, tables that are outside, tall tables, etc.), servers users 106 request, events users 106 attend, etc. Additionally or alternatively, the pattern determination module 128 may determine user patterns associated with characteristics of menu items that the user 106 orders (e.g., taste, preparation, ingredients, etc.). The pattern determination module 128 may determine user patterns associated with whether a user 106 makes reservations, dines-in, orders delivery, and/or orders take-out. In some examples, the pattern determination module 128 may determine user patterns that correspond to frequencies, times, days, dates, holidays, events, dates that correspond to occasions that are personal to users 106 (e.g., birthdays, anniversaries, etc.), etc.

Block 206 illustrates determining entity data 124. The data collection module 120 may receive, access, and/or infer (i.e., determine) entity data 124 from various sources. As described above, for restaurants, entity data 124 may include data associated with information about menus, specials, events, servers, reservations, etc. For other entities 110, such as spas and/or fitness facilities, entity data 124 may include data associated with information about service menus, specials, events, technicians, appointments, etc. and/or entity data 124 may include data associated with information about classes, specials, special events, instructors and/or trainers, appointments, etc., respectively.

Block 208 illustrates receiving an indication of a triggering event. In at least some examples, the recommendation module 130 may receive an indication of a triggering event which may trigger recommendation determination and/or generation. The triggering event may include determining that entity data 124 has been updated, determining that a time, day, and/or date associated a user pattern is upcoming in a predetermined period of time (e.g., within one hour, one day, one week, one month, etc.), determining a presence of a user 106 at an individual entity 110, receiving a reservation request from a user 106, etc. In at least one example, determining that the entity data 124 has been updated may trigger the recommendation module 130 to determine and/or generate a recommendation for a user 106. The data collection module 120 may receive, access, and/or infer updated entity data 124 in predetermined time intervals (e.g., weekly, daily, hourly, etc.), responsive to an event associated with the entity 110, etc., as described above. Receiving, accessing, and/or inferring updated entity data 124 may trigger the recommendation module 130 to determine and/or generate a recommendation. In some examples, changes in the availability of a menu item may trigger recommendation determination and/or generation. As non-limiting examples, determining that a menu item that was previously unavailable is available or determining that a menu item that was previously available is unavailable may trigger recommendation determination and/or generation and/or determining that a menu item is offered on special, is available at a limited supply, and/or is new may trigger recommendation determination and/or generation. In other examples, determining that a time, day, and/or date associated with the user patterns is upcoming in a predetermined period of time may trigger the recommendation module 130 to determine and/or generate a recommendation for a user 106. In additional or alternative examples, detecting a presence of a user 106 at an entity 110 may trigger the recommendation module 130 to determine and/or generate a recommendation for the user 106.

In some examples, the data collection module 120 may determine a presence of a user 106 at an individual entity 110. The data collection module 120 may determine the presence of a user 106 within a predetermined proximity of a geographic location of an entity 110. The data collection module 120 may determine that a user device 108 associated with the user 106 is within a threshold distance of a geographic location of an entity 110. Each entity 110 may have a predetermined distance surrounding the physical location of the entity 110 that may be used for determining the presence of the user 106 at the geographic location of the entity 110. The data collection module 120 may determine that the user device 108 is within a threshold distance of a geographic location of an entity 110 based at least in part on receiving an indication that a user device 108 is within the predetermined distance for a predetermined period of time. Additionally or alternatively, the data collection module 120 may determine that the user device 108 is within a threshold distance of a geographic location of an entity based at least in part on receiving an indication that the user device 108 establishes a connection to a network (e.g., a Wi-Fi network) associated with an entity 110. In some examples, the data collection module 120 may determine that the user device 108 is within a threshold distance of a geographic location of an entity 110 based on user device 108 interaction with a Quick Response (QR) Code, etc.

In additional and/or alternative examples, the recommendation module 130 may determine and/or generate a recommendation for a user 106 based at least in part on a user 106 requesting a reservation at an entity 110. For instance, a user 106 may request a reservation at a restaurant. The recommendation module 130 may generate a deal to be offered to the user 106, an action to be provided by the restaurant, etc. In at least one example, based at least in part on receiving a reservation request from a user 106, the recommendation module 130 may send data associated with user patterns of the user 106 to the entity 110 so that the entity 110 may check inventory and/or otherwise take actions to ensure that goods and/or services associated with the user patterns are available for the user's 106 reservation.

In at least one example, the recommendation module 130 may determine and/or generate recommendations without receiving an indication of a triggering event. The recommendation module 130 may determine and/or generate recommendations at a predetermined frequency, in predetermined time intervals, etc. In some examples, the predetermined frequencies and/or predetermined time intervals may be associated with user patterns. In other examples, the predetermined frequencies and/or predetermined time intervals may not be associated with user patterns. The recommendation module 130 may compare user patterns to entity data 124 and based on the comparing, may determine and/or generate a recommendation for a user 106, as described below.

Block 210 illustrates generating a recommendation. The recommendation module 130 may determine and/or generate recommendations for users 106 based on the user patterns associated with individual entities 110, as described above. The recommendation module 130 may compare user patterns to entity data 124 and based on the comparing, may determine and/or generate a recommendation for a user 106, as described above. In at least one example, the recommendation module 130 may access user data 122 and/or performance data 126 to determine whether to determine and/or generate a recommendation for a user 106. In some examples, the user data 122 may indicate that a user 106 is a loyal user, and accordingly, may determine not to determine and/or generate a recommendation for a user 106. In other examples, the user data 122 may indicate that a user 106 is a loyal user, and accordingly, may determine and/or generate a recommendation for a user 106 that provides premium benefits to the loyal customer, as described above. In additional and/or alternative examples, the recommendation module 130 may access performance data 126 to determine that a user 106 has previously ignored recommendations at a frequency above a predetermined threshold and/or a predetermined number of times such to indicate that the user 106 is not interested in receiving recommendations. Accordingly, the recommendation module 130 may determine not to determine and/or generate a new recommendation for a user 106. The recommendation module 130 may send the recommendations to the presentation module 132 and the presentation module 132 may cause the recommendations to be presented to the user 106 via a user interface of the user device 108.

In some examples, the recommendation module 130 may send a recommendation to the presentation module 132 at a predetermined frequency, after a lapse of a predetermined time interval, responsive to a triggering event, etc. In other examples, the presentation module 132 may cause the recommendations to be presented to the users 106 (via corresponding user devices 108) on or before the dates that correspond to user patterns and/or in frequencies that correspond to user patterns, as described above. The recommendations may include content that is personal to the user 106 and an entity 110. The recommendations may include reservations at the entity 110, deals offered by the entity 110, actions to be provided by the entity 110, invitations to events hosted and/or sponsored by the entity 110, etc.

In at least some examples, the data collection module 120 may determine that the user 106 made a reservation responsive to receiving the recommendation from the service provider 102 and/or entity 110, acquired a deal responsive to receiving the recommendation from the service provider 102 and/or entity 110, etc., and may cause the information to be presented to the entity 110 so that the entity 110 can perform an action that is associated with the user patterns and/or recommendations. In some examples, the service provider 102 may automatically reserve menu items, tables, servers, etc. In other examples, the service provider 102 may provide the information to the entity 110 and people associated with the entity 110 may manually enter the information to reserve menu items, tables, servers, etc. As a non-limiting example, if the recommendation module 130 recommends a reservation to the user 110 on a day that a main dish that the user patterns indicate the user 106 has an affinity for is offered as a special, if the user 106 makes a reservation, the service provider 102 and/or entity 110 may reserve the main dish so that the main dish is available when the user 106 shows up to the entity 110 for his or her reservation.

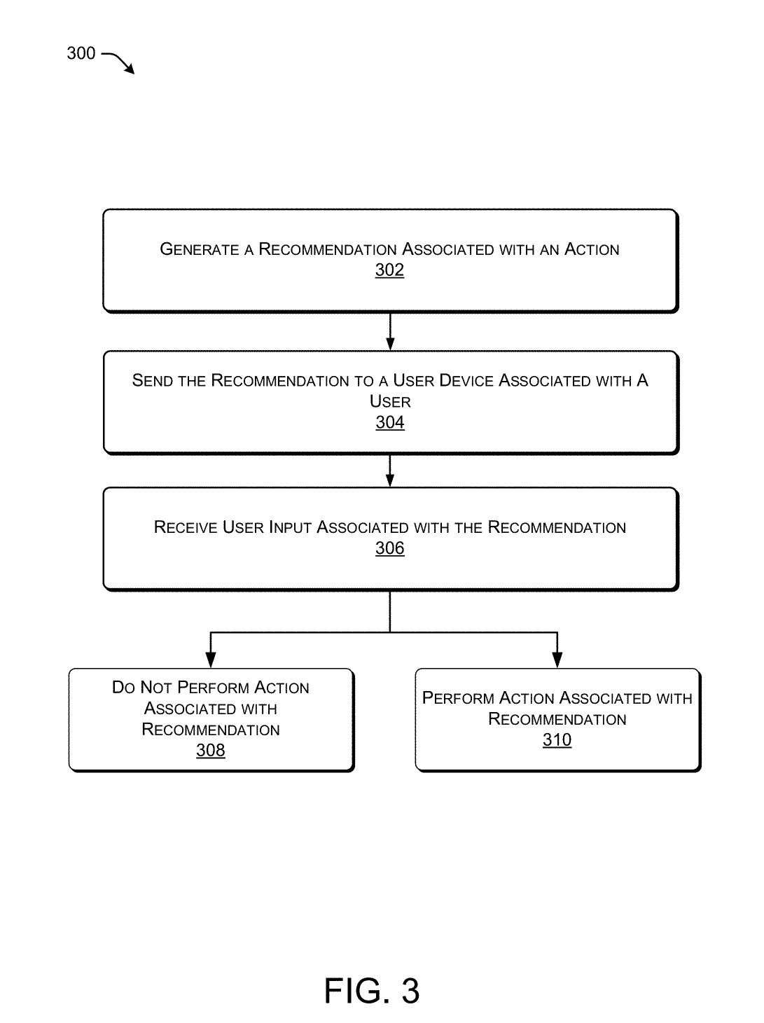

FIG. 3 is a flow diagram showing an illustrative process 300 for performing actions associated with recommendations that are based on user patterns. The operations described with respect to FIG. 3 may be performed by the service provider 102 (e.g., the content servers 114) and/or an entity device 112, as described above and as illustrated in FIG. 1.

Block 302 illustrates generating a recommendation associated with an action. Based at least in part on determining user patterns as described above, the recommendation module 130 may determine and/or generate the recommendation. As described above, the recommendation may include a reservation, deal, invitation to an event, etc. In at least one example, the recommendation may include an action to be provided by an entity 110 that the pattern determination module 128 has determined to be associated with a user 106 and the entity 110. The action may be associated with one or more goods and/or services offered by the entity 110. The action may be associated with in-entity (i.e., dine-in) actions, delivery actions, and/or carry-out actions. The recommendation may include a mechanism for the user 106 to either confirm or cancel the instructions, as described below.

As a non-limiting example, the user 106 may order a particular sandwich for delivery from Restaurant A every Monday at 12:00 pm. Accordingly, the recommendation module 130 may determine and/or generate a recommendation for the user 106 associated with the sandwich and Restaurant A. For instance, the recommendation may include a recommendation to send instructions to Restaurant A to deliver the sandwich to the user 106 at 12:00 pm on Monday. As another non-limiting example, the pattern determination module 128 may determine that a user 106 picks up (i.e., carries out) pho every day at 12:00 am from Restaurant B. The recommendation module 130 may determine and/or generate a recommendation for the user 106 associated with Restaurant B and the user pattern. For instance, the recommendation may include a recommendation to send instructions to Restaurant B to start preparing the pho at a predetermined time before 12:00 pm. As another non-limiting example, the pattern determination module 128 may determine that a user 106 schedules a pedicure every Friday at 5:30 pm at Spa A. The recommendation module 130 may determine and/or generate a recommendation for the user 106 associated with Spa A and the user pattern. For instance, the recommendation may include a recommendation to send instructions to Spa A to start preparing the soaking tub on Friday at a predetermined time before 5:30 pm.

Block 304 illustrates sending the recommendation to a user device 108 associated with a user 106. The presentation module 132 may cause recommendations to be presented to the users 106 via user devices 108, as described above and below. The recommendations may be associated with mechanisms that prompt the user 106 to cancel or confirm the action associated with the recommendation.

Block 306 illustrates receiving user input associated with the recommendation. In some examples, a user 106 may actuate a control on a user interface associated with the recommendation to confirm or cancel the action, interact with the user device 108 via sound input, biometric input, etc., etc. to confirm or cancel the recommended action. Based at least in part on the user 106 actuating the control and/or performing some other interaction with the user device 108 to cancel the action, the service provider 102 may not communicate the information to the entity 110 and the entity 110 may refrain from performing the action associated with the recommendation, as illustrated in Block 308.

In other examples, a user 106 may actuate a control on a user interface or otherwise interact with the user device 108 to confirm the action, and based at least in part on the user's 106 actuation of the control and/or other interaction with the user device 108, the service provider 102 may communicate the information to the entity 110 and the entity 110 may perform the action associated with the recommendation, as illustrated in Block 310. That is, based at least in part on receiving confirmation from a user 106, the user's 106 order may be automatically processed. In at least one example, based at least in part on receiving the user input, the presentation module 132 may cause a confirmation to be presented to the user 106 via a user interface, email, text message, push notification, etc. The confirmation may include the pick-up/delivery location, estimated pick-up/delivery time, total charge, special instructions, etc.

In some examples, the service provider 102 and/or entity 110 may not send a recommendation to the user 106 and may simply initiate the action without any commitment from the user 106. That is, the service provider 102 may leverage user patterns to initiate actions consistent with the user patterns without any commitment from the user 106. In such examples, if the user 106 interacts with the entity 110 in a manner consistent with user patterns associated with the user 106, the entity 110 is prepared and can quickly and personally serve the user 106.

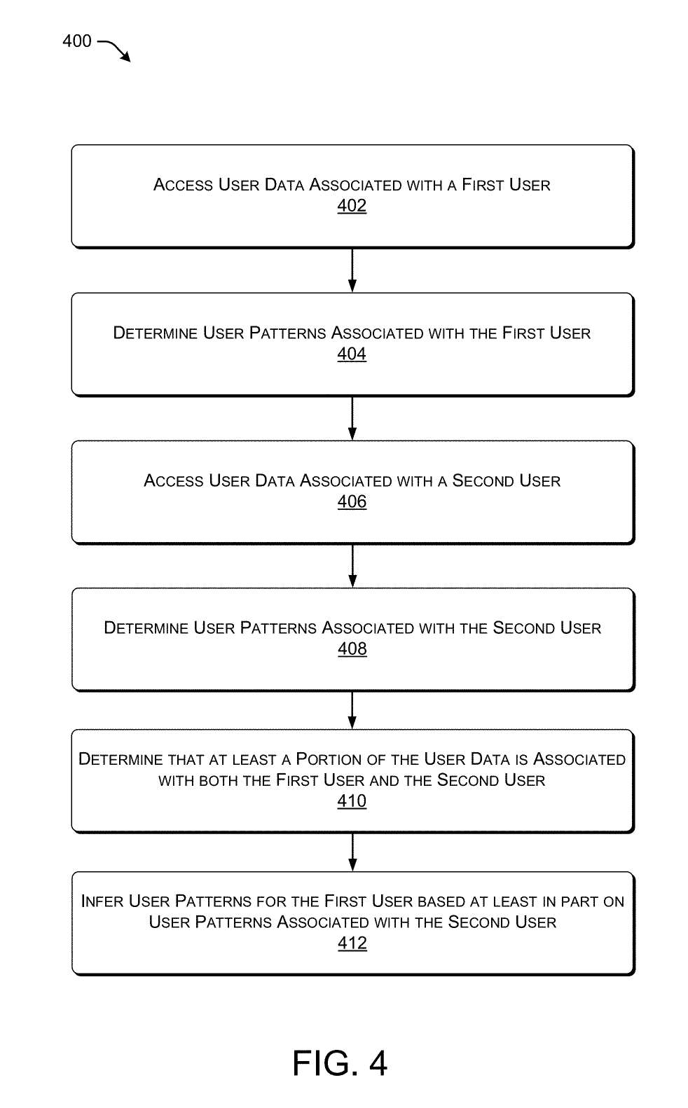

FIG. 4 is a flow diagram showing an illustrative process to infer user patterns for a first user 106 based on user patterns associated with a second user 106. The operations described with respect to FIG. 4 may be performed by the service provider 102 (e.g., the content servers 114) and/or an entity device 112, as described above and as illustrated in FIG. 1.

Block 402 illustrates accessing user data 122 associated with a first user 106. The pattern determination module 128 may access user data 122 associated with the first user 106 from the database associated with the user data 122, as described above.

Block 404 illustrates determining user patterns associated with the first user 106. The pattern determination module 128 may determine user patterns based at least in part on the user data 122, as described above.

Block 406 illustrates accessing user data 122 associated with a second user 106. The pattern determination module 128 may access user data 122 associated with the second user 106 from the database associated with the user data 122, as described above.

Block 408 illustrates determining user patterns associated with the second user 106. The pattern determination module 128 may determine user patterns based at least in part on the user data 122, as described above.

Block 410 illustrates determining that at least a portion of the user data 122 is associated with both the first user 106 and the second user 106. The data collection module 120 and/or the pattern determination module 128 may compare the user data 122 associated with the first user 106 and the user data 122 associated with the second user 106 and may determine that the first user 106 and the second user 106 share at least some user data 122 and/or user patterns. As a non-limiting example, the data collection module 120 and/or the pattern determination module 128 may compare the first user's 106 orders to the second user's 106 orders at the restaurant and may determine that both the first user 106 and the second user 106 ordered seabass lettuce cups as an appetizer and a seabass main dish that is marinated in yellow curry and served on a mango salsa. In an additional and/or alternative example, the pattern determination module 128 may determine user patterns for the first user 106 and the second user 106 representing both users' 106 affinities for the ingredient of seabass.

Block 412 illustrates inferring user patterns for the first user 106 based at least in part on user patterns associated with the second user 106. Based at least in part on determining that the first user 106 and the second user 106 have at least some data and/or user patterns associated with the entity 110 that are the same, the pattern determination module 128 may determine that user patterns associated with the second user 106 may also be representative of user patterns associated with the first user 106. In the non-limiting example above, the pattern determination module 128 may determine that the second user 106 exhibits an affinity for a green papaya salad (e.g., determine a user pattern between the second user 106 and the green papaya salad). Accordingly, the pattern determination module 128 may determine that the first user 106 may like the green papaya salad. The recommendation module 130 may leverage the inferred user patterns to determine and/or generate recommendations for the first user 106. Accordingly, in the non-limiting example above, the recommendation module 130 may determine and/or generate a recommendation for a deal for the green papaya salad.

In some examples, the pattern determination module 128 may determine that the user data 122 associated with a user 106 is insufficient to determine user patterns for recommending goods and/or services to the user 106. In such examples, the recommendation module 130 may determine and/or generate recommendations based at least in part on accessing user data 122 associated with the user 106, such as demographic data, etc., and applying machine learning algorithms to the user data 122 to identify goods and/or services to recommend to the user 106.

In some examples, the service provider 102 may share information associated with entities 110 between the entities 110. For instance, using aggregated user data 122, the service provider 102 may identify user patterns associated with a plurality of users 106 and may enable other entities 110 to utilize the user patterns to improve their goods and/or services, targeted marketing, etc. In a non-limiting example, the pattern determination module 128 may determine that a plurality of users 106 that share one or more attributes (e.g., age, income, neighborhood, user patterns, etc.) exhibit a same user pattern associated with a particular entity 110, good and/or service, etc. The service provider 102 may provide information about the plurality of users 106 to another entity 110. In at least one example, the entities 110 that are receiving the information may be required to subscribe to the services offered by the service provider 102. Additionally and/or alternatively, entities 110 may be offered incentives from the service provider 102 to encourage the entities 110 to share information with other entities 110. In some examples, entities 110, such as the first entity 110 and/or the second entity 110 described below, may receive a discount for the services associated with the service provider 102 based at least in part on agreeing to share data as described above. In other examples, the entities 110 may share revenues, etc.

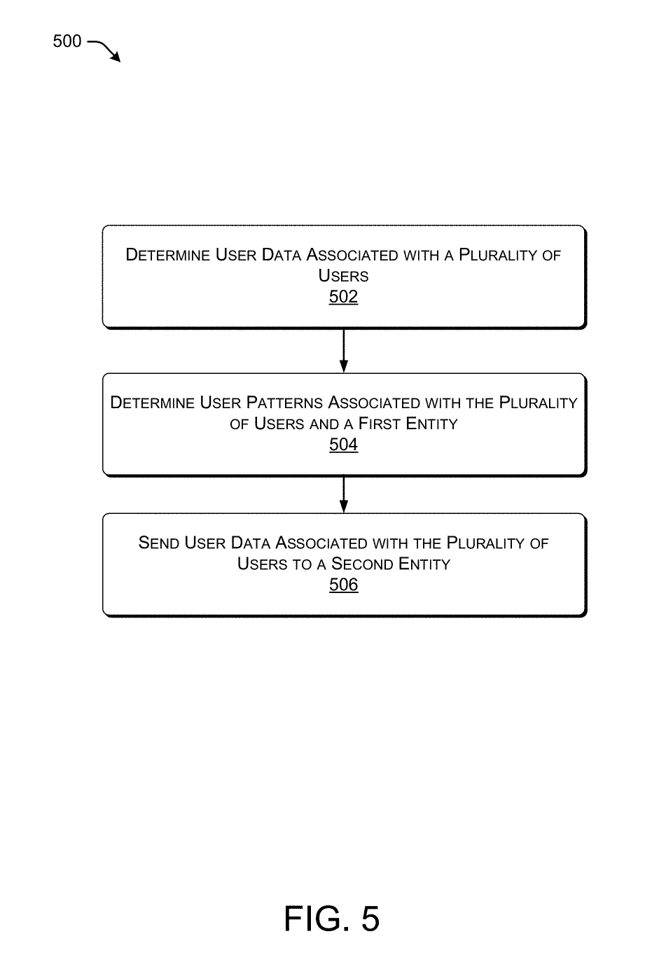

FIG. 5 is a flow diagram showing an illustrative process 500 to share user data 122 between entities 110. The operations described with respect to FIG. 5 may be performed by the service provider 102 (e.g., the content servers 114) and/or an entity device 112, as described above and as illustrated in FIG. 1.

Block 502 illustrates determining user data 122 associated with a plurality of users 106. The data collection module 120 may receive, access, and/or infer user data 122 associated with the plurality of users 106, as described above.

Block 504 illustrates determining user patterns associated with the plurality of users 106 and a first entity 110. As described above, the pattern determination module 128 may utilize machine learning algorithms to learn patterns between the plurality of users 106 and a first entity 110, based at least in part on the user data 122 associated with the plurality of users 106. That is, the pattern determination module 128 may learn user patterns based on aggregated user data 122 associated with the plurality of users 106.

Block 506 illustrates sending user data 122 associated with the plurality of users 106 to a second entity 110. In some examples, the first entity 110 and the second entity 110 may share at least some characteristics. For instance, the first entity 110 and the second entity 110 may both serve a same type of cuisine (e.g., American, Indian, Asian, etc.), have waterfront dining options, etc. In other examples, the first entity 110 and the second entity 110 may not share any characteristics but, users 106 who interact with the first entity 110 at a frequency above a predetermined threshold and/or a predetermined number of times may also interact with the second entity 110 at a frequency above the predetermined threshold and/or the predetermined number of times. Accordingly, the pattern determination module 128 may learn that users 106 who have an affinity for the first entity 110 may also have an affinity for the second entity 110.

Based at least in part on the pattern determination module 128 determining that the users 106 who have an affinity for the first entity 110 also have an affinity for the second entity 110, the recommendation module 130 may send recommendations to the second entity 110. The second entity 110 may be an entity 110 that has at least some features that are similar to the first entity 110 and/or the second entity 110. The recommendations may include lists of users 106 who are likely to be good candidates for targeted marketing from the second entity 110 based at least on their affinity for the first entity 110. The recommendation module 130 may provide additional and/or alternative information about specific user patterns to the second entity 110.

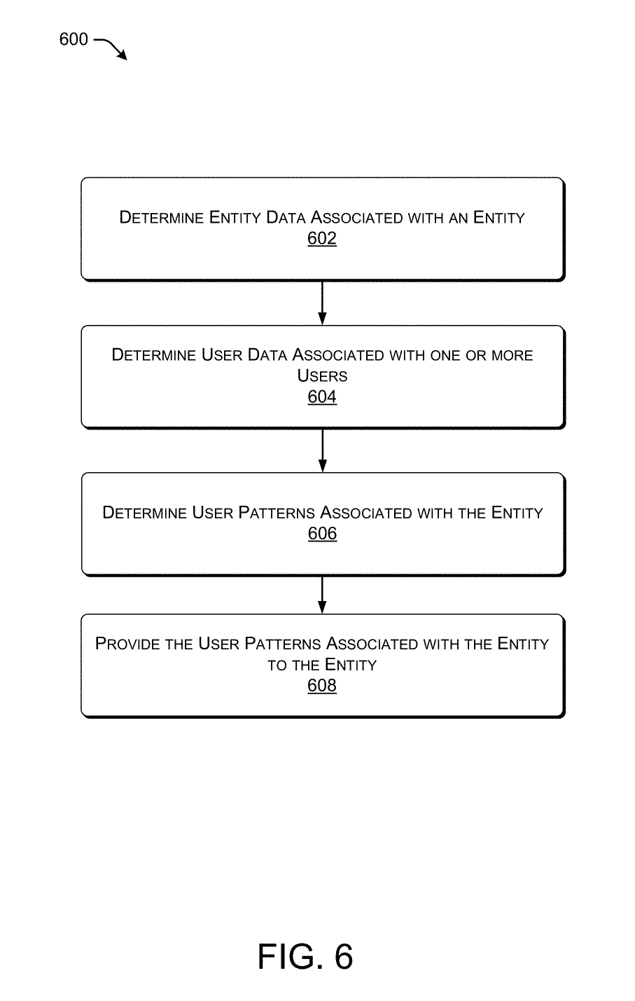

FIG. 6 is a flow diagram showing an illustrative process 600 to provide user patterns 122 associated with an entity 110 to the entity 110. The operations described with respect to FIG. 6 may be performed by the service provider 102 (e.g., the content servers 114) and/or an entity device 112, as described above and as illustrated in FIG. 1.

Block 602 illustrates determining entity data 124 associated with an entity 110. As described above, the data collection module 120 may receive, access, and/or infer entity data 124 associated with the entity 110.

Block 604 illustrates determining user data 122 associated with one or more users 106. The data collection module 120 may receive, access, and/or infer user data 122 associated with one or more users 106, as described above.

Block 606 illustrates determining user patterns associated with the one or more users 106 and the entity 110. As described above, the pattern determination module 128 may utilize machine learning algorithms to learn patterns associated with the one or more users 106 and the entity 110, based at least in part on the user data 122 associated with the one or more users 106. That is, user data 122 associated with individual users 106 may be aggregated and the pattern determination module 128 may determine user patterns associated with interactions of the one or more users 106 and the entity 110.

Block 608 illustrates providing the user patterns associated with the entity 110 to the entity 110. The presentation module 132 may send information to the entities 110. In such examples, the information may include data and/or metrics associated with the performance of individual menu items, tables, servers, etc. Additionally or alternatively, the information may include user feedback, etc. In at least one example, the entities 110 may leverage the user patterns associated with each of the entities 110 to manage inventory and/or make changes to the goods and/or services offered by the entities 110. For instance, entities 110 may utilize the information to make strategic changes to menu items, tables, servers, etc. In a non-limiting example, if the pattern determination module 128 determines that the one or more users 106 have an affinity for filet dishes but that a salmon dish is underperforming, the entity 110 may decide to replace the salmon dish with another filet dish. In addition to using aggregated user data 122, the entity 110 may also utilize user data 122 associated with individual users 106 to determine whether menu changes might affect loyal users 106. For instance, if the salmon dish is generally underperforming, but a loyal user regularly orders the salmon dish, the entity 110 may be more cautious in its decision to remove the salmon dish from the menu.

FIG. 7 is a diagram showing an example user interface 700 that may be presented to a user 106 with a recommendation that is based on user patterns. The presentation module 132 may cause a user interface 700 to be presented to users 106 utilizing any communication channel, such as an e-mail message, a site (e.g., website) associated with the service provider 102, a text message, a social network site, an application that is associated with the service provider 102 and that resides on user device(s) 108 of the users 106, etc. The presentation module 132 may cause the recommendations to be presented to the user 106 on or before a time, day, and/or date that is associated with a user pattern, at a frequency associated with a user pattern, at regular frequencies and/or time intervals, responsive to a triggering event, etc. The user interface 700 may include personalized content 702 that is based on user patterns. As a non-limiting example, the pattern determination module 128 may have determined that the user 106 orders a bottle of Oyster Bay Sauvignon Blanc at Restaurant A at a frequency above a predetermined threshold during a predetermined period of time such that the user 106 appears to have an affinity for Oyster Bay Sauvignon Blanc. The recommendation module 130 may receive entity data 124 indicating that Oyster Bay Sauvignon Blanc is being offered at a discounted price for the week. Accordingly, the user interface 700 may include personalized content 702 recommending a reservation for a day during the week that Oyster Bay Sauvignon Blanc is being offered as a special at Restaurant A.

In FIG. 7, the entity 110 is a restaurant, Restaurant A. The user interface 700 may include information that describes the entity 110 (e.g., Restaurant A) and one or more images, photos, etc., 704 that represent the entity 110 (e.g., Restaurant A), the subject matter of the recommendation (e.g., a menu item, table, server, etc.). In some examples, a user 106 may elect to make a reservation by actuating a control 710 on the user interface (or, via some other user interaction such as voice input, biometric input, etc.). In at least one example, the user 106 may specify multiple variables (e.g., date, time, party size, table features, etc.) from drop down menus (e.g., time drop down menu 706, and party size drop down 708, etc.) prior to actuating the control 710 to request the reservation. In some examples, variables may be pre-selected via user profiles, user patterns, etc. In additional or alternative examples, the service provider 102 may recommend times, party size, etc. for the user 106 based on user data 122 and/or user patterns. In such examples, the service provider 102 may auto-populate the drop down menus. Drop down menus are shown for illustrative purposes only and any type of representation may be used to indicate or display the multiple variables. In other examples, the presentation module 132 may prompt the user 106 for additional information responsive to the user 106 actuating the control 710 to request a reservation. For instance, the presentation module 132 may prompt the user 106 for a time associated with the reservation request, a number of users 106 in the user's 106 party, payment information, special requests, etc.

In at least one example, the presentation module 132 may cause a reservation confirmation to be presented to the user 106 via a user interface, email, text message, push notification, etc. The reservation confirmation may include the date, time, and any other user 106 requests. The reservation confirmation may also include additional information such as driving directions, parking information, public transportation options, etc. Additionally or alternatively, the reservation confirmation may include service or food/beverage menus, specials, suggested activities, events, etc. occurring prior to and/or after the reservation time, etc.

In additional and/or alternative examples, the presentation module 132 may cause a reservation confirmation and/or information associated with the reservation to be presented to the entity 110 via a user interface, email, text message, push notification, etc. The reservation confirmation may include the date, time, and any other user 106 requests. The reservation confirmation and/or information associated with the reservation may also include additional information such as a request to reserve goods and/or services, tables, etc. that correspond to the personalized content 702 and/or additional or alternative user patterns. As a non-limiting example, at some time prior to the reservation, the entity 110 may reserve a main dish that the pattern determination module 128 determined to be associated with a user pattern associated with the user 106 to ensure the main dish is available when the user 106 arrives. As an additional non-limiting example, at some time prior to the reservation, the entity 110 may check the inventory associated with a wine (e.g., Oyster Bay Sauvignon Blanc) that the pattern determination module 128 determined to be associated with a user pattern associated with the user 106 to ensure the wine is available when the user 106 arrives. In some examples, if the wine is out of stock, the entity 110 can take one or more actions (e.g., buy at a retailer, expedite an order, etc.) to ensure the entity 110 has the wine in stock for the user's 106 reservation.

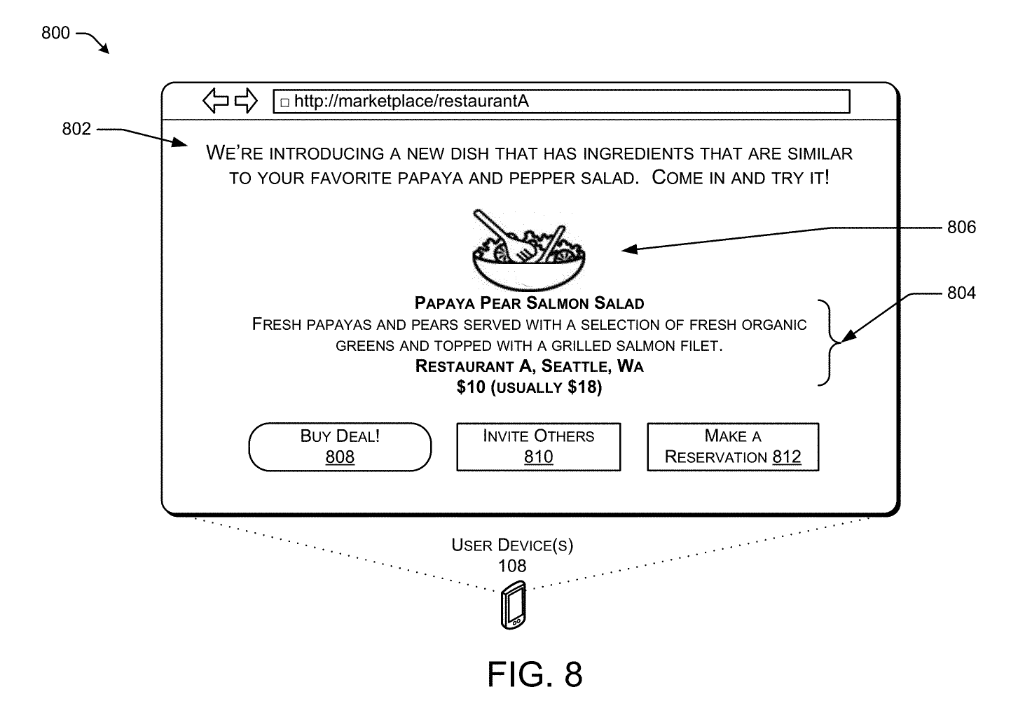

FIG. 8 is a diagram showing an example user interface 800 that may be presented to a user 106 with a recommendation that is based on user patterns. As described above, the presentation module 130 may cause a user interface 800 to be presented to users 106 utilizing any communication channel, such as an e-mail message, a site (e.g., website) associated with the service provider 102, a text message, a social network site, an application that is associated with the service provider 102 and that resides on user device(s) 108 of the users 106, etc. In some examples, the presentation module 130 may cause the recommendations to be presented to the user 106 on or before a time, day, and/or date that is associated with a user pattern and/or at a frequency that is associated with a user pattern.

The user interface 800 may include personalized content 802 that is based on user patterns. As a non-limiting example, the pattern determination module 128 may determine that the user 106 orders a papaya and pepper salad at Restaurant A at a frequency above a predetermined threshold and/or a predetermined number of times such to indicate an affinity between the user 106 and the papaya and pepper salad. The recommendation module 130 may compare the user pattern with the entity data 124 and determine that the user 106 may be interested in trying a new papaya pear salmon salad, based on the salads having similar ingredients (e.g., papaya), taste (e.g., sweet), and/or preparations (e.g., fresh cut/hand tossed). Accordingly, the user interface 800 may include personalized content 802 promoting a deal for the new salad at Restaurant A.

As shown, the user interface 800 may include deal information 804 that describes the deal and an image, photo, etc., 806 that represents the items associated with the deal (i.e., a salad). For instance, the deal information 804 may include the item(s) (e.g., products, services, etc.) being offered in the deal. For instance, for the purposes of FIG. 8, the item featured in the deal is the papaya pear salmon salad. The deal information 804 includes descriptive information that explains the ingredients and preparation of the papaya pear salmon salad. The deal information 804 may also specify the location in which the deal is to be redeemed (e.g., Seattle, Wash.), the entity 110 associated with the deal (Restaurant A), and/or other information. The user interface 800 may also include information relating to the price of the deal (e.g., $10).

A user 106 may acquire the deal by actuating a “Buy Deal!” control 808. Before, during, or after the user 106 acquires the deal, the user 106 may provide additional information relevant to the acquisition of the deal, such as how many deals the user 106 would like to acquire, relevant payment information, personal preferences, a number of users 106 in his or her group, etc. At 810, before, during, or after the user 106 acquires the deal, the user 106 may also invite other users 106, who may be in a same social graph as the user 106, to acquire the deal and to redeem the deal with the user 106. The user 106 may input contact information (e.g., e-mail addresses, telephone numbers, unique identifiers, etc.) for the other users 106, which may cause the service provider 102 to send a notification to those other users 106. The other users 106 may then have the opportunity to acquire the same deal as the user 106. In some examples, before, during, or after the user 106 acquires the deal, the user 106 may request to view related deals. Related deals may include deals relating to transportation services for transporting the user 106 (and his or her group) to the entity 110 offering the presented deal, other deals associated with the same entity 110, other deals offered by entities 110 offering similar services to the deal, etc. At 812, the user 106 may elect to make a reservation with the entity 110 offering the deal. In addition to and/or as an alternative to actuating controls (e.g., 808, 810, 812) on the user interface 800, a user may interact with the user interface 800 via another user interaction such as voice input, biometric input, etc.

In some examples, based at least on determining that the user 106 elected to make a reservation for the entity 110 offering the deal, the service provider 102 may provide data to the entity 110 associated with the reservation and a request to reserve the goods and/or services associated with the deal so that the goods and/or services are available when the user 106 arrives for the reservation.

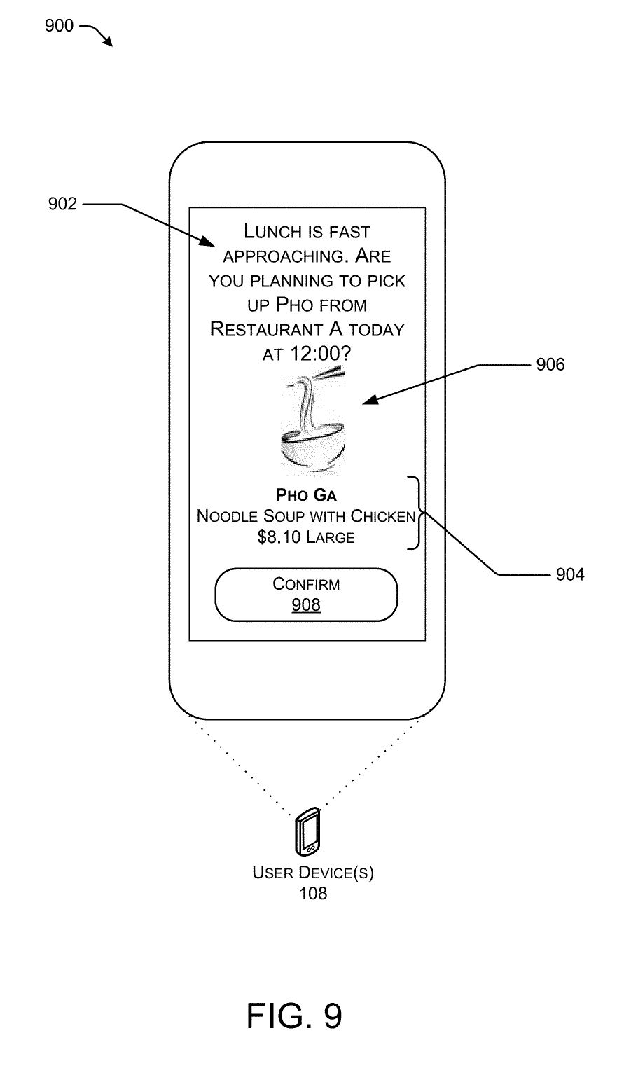

FIG. 9 is a diagram showing an example user interface 900 that may be presented to a user 106 with a recommendation that is based on user patterns. As described above, the presentation module 130 may cause a user interface 900 to be presented to users 106 utilizing any communication channel, such as an e-mail message, a site (e.g., website) associated with the service provider 102, a text message, a social network site, an application that is associated with the service provider 102 and that resides on user device(s) 108 of the users 106, etc. In some examples, the presentation module 130 may cause the recommendations to be presented to the user 106 on or before a time, day, and/or date that is associated with a user pattern and/or at a frequency associated with a user pattern.

The user interface 900 may include personalized content 902 that is based on user patterns. As a non-limiting example, the pattern determination module 128 may determine that the user 106 orders pho ga at Restaurant A at 12:00 pm on Tuesdays at a frequency above a predetermined threshold and/or a predetermined number of times such to indicate an affinity between the user 106 and the pho ga and/or a likelihood that the user 106 will order the pho ga at Restaurant A at 12:00 pm on Tuesday. Accordingly, the user interface 900 may include personalized content 902 indicating an action to be provided by the entity 110 (e.g., Restaurant A) associated with the user pattern.

As shown, the user interface 900 may include information 904 that describes the order and an image, photo, etc., 906 that represents the items associated with the order (i.e., a salad). For instance, the recommendation information 904 may include the item(s) (e.g., products, services, etc.) associated with the action and/or the action to be provided by the entity 110. For instance, for the purposes of FIG. 9, the item featured in the recommendation is pho ga, a noodle soup with chicken. The recommendation information 904 also includes descriptive information that explains the ingredients in the pho ga, information relating to the price of the order (e.g., $8.10), etc. The user interface 900 may include additional or alternative information associated with the order.

A user 106 may confirm the action by actuating a “Confirm” control 908 (or, via some other user interaction such as voice input, biometric input, etc.). Before, during, or after the user 106 confirms the action, the user 106 may provide additional information relevant to the action, such as relevant payment information, special instructions, etc. In other examples, the user interface 900 may include a “Cancel” control and the user 106 may cancel the action by actuating the “Cancel” control (or, via some other user interaction such as voice input, biometric input, etc.).

In at least one example, the presentation module 132 may cause an order confirmation to be presented to the user 106 via a user interface, email, text message, push notification, etc. The confirmation may include the pick-up/delivery location, estimated pick-up/delivery time, total charge, special instructions, etc. The order confirmation may also include additional information such as driving directions, parking information, public transportation options, etc.

The user interfaces 700-900 are examples of user interfaces that include personalized content that are presented to users 106. In FIGS. 7-9, a restaurant entity 110 is shown for illustrative purposes. However, any other presentation or configuration may be used for any type of entity 110 as described above.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A system comprising:
one or more processors;
memory; and
one or more computer-executable instructions stored in the memory and executable by the one or more processors to perform operations comprising:
determining restaurant data associated with a restaurant, the restaurant data including a plurality of menu items offered by the restaurant;
determining user data that is representative of a behavior of a user with respect to the restaurant, the user data including data associated with menu items of the plurality of menu items ordered by the user from the restaurant;
determining, based on the user data, a user pattern associated with the user and a menu item of the menu items ordered by the user from the restaurant, the user pattern being determined based on applying a machine learning algorithm to the user data to generate the user pattern and at least one of a frequency in which the user ordered the menu item or a number of times the user ordered the menu item;
receiving updated restaurant data indicating that at least one of an availability of the menu item changed or that the menu item is being offered at a discounted price; and
based at least in part on the updated restaurant data and the user pattern, generating a recommendation to be provided to a user device associated with the user, the recommendation being associated with a reservation for the restaurant.

2. The system of claim 1, the operations further comprising:
comparing the user data to the updated restaurant data;
based on comparing the user data to the updated restaurant data, determining an alternative menu item offered by the restaurant to recommend to the user; and
generating a deal that is redeemable by the user for the alternative menu item.

3. The system of claim 1, the operations further comprising determining, based on the user data, an additional user pattern associated with the user and at least one of a table at the restaurant, a server at the restaurant, or a date, wherein the reservation is associated with at least one of the table, the server, or the date.

4. The system of claim 1, the operations further comprising:
generating a user interface that provides functionality to the user to request the reservation; and
providing the user interface to the user device.

5. The system of claim 4, the operations further comprising:
generating a notification indicating at least one of that the availability of the menu item changed or that the menu item is being offered at the discounted price; and
providing the notification and the user interface to the user device.

6. A method comprising:
determining data associated with interactions between a user and a restaurant;
determining, based at least in part on the data, a pattern associated with the user and menu items offered by the restaurant, the pattern being determined based at least in part on at least one of a frequency in which the menu items were requested or a number of times the menu items were requested;
based at least in part on the pattern, generating a recommendation that is associated with at least one of a reservation for the restaurant, an action associated with the menu items to be provided by the restaurant, or a deal associated with the menu items that is redeemable at the restaurant; and
sending the recommendation to a device associated with the user.

7. The method of claim 6, further comprising determining that the pattern corresponds to at least one of an ingredient included in a menu item of the menu items or a preparation of the menu item.

8. The method of claim 6, further comprising determining that the pattern corresponds to the user and one or more other users who are associated with a same social graph as the user.

9. The method of claim 6, further comprising:
determining that the pattern corresponds to a time;
generating the recommendation for the action associated with the menu items to be provided by the restaurant at or before the time; and
sending the recommendation for the action to the device a predetermined period of time before the time.

10. The method of claim 9, further comprising:
receiving input associated with the recommendation; and
based at least in part on the input, at least one of:
based at least in part on a first determination that the input confirmed performance of the action, sending a first instruction to the restaurant to perform the action; or
based at least in part on a second determination that the input canceled performance of the action, sending a second instruction to the restaurant to refrain from performing the action.

11. The method of claim 6, further comprising:
determining that a menu item of the menu items that was previously unavailable is available;
generating a notification indicating that the menu item is available; and
sending the notification and the recommendation to the device.

12. The method of claim 6, further comprising:
determining that a menu item of the menu items that was previously available is unavailable;
comparing the data to restaurant data associated with the menu items;
based at least in part on comparing the data to the restaurant data associated with the menu items, determining an alternative menu item offered by the restaurant to recommend to the user; and
determining that the recommendation for the restaurant includes the deal that is redeemable by the user, the deal being associated with the alternative menu item.

13. The method of claim 6, further comprising:
determining that the user has interacted with the restaurant at least one of a second frequency above a predetermined threshold or a predetermined number of times;
determining that the user qualifies for premium benefits that are different from benefits associated with users that have interacted with the restaurant at a third frequency below the predetermined threshold or fewer than the predetermined number of times;
determining that the device is within a predetermined distance from a physical location associated with the restaurant; and
based at least in part on determining that the device is within the predetermined distance from the physical location associated with the restaurant, determining that the recommendation is associated with one or more premium benefits of the premium benefits.

14. A system comprising:
one or more processors;
memory; and
one or more computer-executable instructions stored in the memory and executable by the one or more processors to perform operations comprising:
determining data associated with interactions between users and an entity;
determining, based at least in part on the data, one or more patterns associated with a user of the users and the entity, the one or more patterns representing one or more affinities between the user and at least one of goods or services offered by the entity and being determined based at least in part on at least one of:
a frequency in which at least one of the goods or the services were requested by the user or on behalf of the user; or
a number of times at least one of the goods or the services were requested by the user or on behalf of the user;
determining entity data associated with the entity, the entity data including data associated with at least one of the goods or the services offered by the entity; and
based at least in part on an availability of at least one of the goods or the services, generating one or more recommendations associated with the one or more patterns and the entity data.

15. The system of claim 14, the operations further comprising sending the one or more recommendations to a device associated with the user at a predetermined frequency or a predetermined time.

16. The system of claim 14, the operations further comprising determining the patterns by:
determining a second pattern associated with a second user of the users based at least in part on second data associated with the second user;
determining that at least a first portion of the data corresponds to at least a second portion of the second data; and
inferring the one or more patterns based at least in part on the second pattern.

17. The system of claim 14, the operations further comprising:
determining that the one or more recommendations are associated with a reservation for the entity;
receiving input associated with requesting the reservation; and
sending data associated with the reservation to the entity, the data being associated with a request to reserve at least one of the goods or the services.

18. The system of claim 14, the operations further comprising determining that the one or more recommendations are associated with an action associated with at least one of the goods or the services provided by the entity.

19. The system of claim 18, the operations further comprising determining that the action comprises delivering the at least one of the goods or the services to the user or preparing the at least one of the goods or the services for pick-up by the user at the entity.

20. The system of claim 14, the operations further comprising determining that the one or more recommendations are associated with a deal that is associated with at least one of the goods or the services that is redeemable by the user.
